(19) United States
(12) Patent Application Publication
(10) Pub. No.: US 2007/0265414 A1
(43) Pub. Date: Nov. 15, 2007

(54) PROCESS FOR PREPARING POLYARYLENE ETHER KETONES

(75) Inventors: Alexander Richter, Oer-Erkenschwick (DE); Vera Schiemann, Marl (DE); Jurgen Maul, Marl (DE); Bernd Gunzel, Haltern am See (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/746,718

(22) Filed: May 10, 2007

(30) Foreign Application Priority Data
May 15, 2006 (DE) 102006022550.3

(51) Int. Cl. C08G 8/02

(52) U.S. Cl. 528/125

(57) ABSTRACT

A process for preparing a polyarylene ether ketone by reacting an aromatic dihalogen compound with a bisphenol in the presence of alkali metal carbonate and/or alkaline earth metal carbonate in a high-boiling solvent, where the molar mass is established by, in the course of the polycondensation, bringing the molar mass to a target value by again adding a bisphenol or an aromatic dihalogen compound to the reaction.

### FIELD OF THE INVENTION

The invention provides a process for preparing polyarylene ether ketones (PAEK) in which the desired molar mass can be set in a controlled manner.

### BACKGROUND OF THE INVENTION

Polyarylene ether ketones are prepared by polycondensation in a conventional preparation method. In this so-called nucleophilic route, a suitable organic diol compound is reacted with a suitable organic dihalogen compound. The reaction is typically carried out in a solvent, for example diphenyl sulfone, using so-called auxiliary bases which are present as solid constituents in the reaction mixture; typically, a mixture of sodium carbonate and potassium carbonate is used here in approximately stoichiometric amount. This preparation method is described in a multitude of patent applications, for example in EP-A-0 001 879, EP-A-0 182 648 and EP-A-0 244 167. Typically, for the preparation of PAEK, aromatic difluoro compounds and bisphenols are used; for instance, in the preparation of polyether ether ketone (PEEK) by the nucleophilic route, the diol component used is hydroquinone and the dihalogen component 4,4′-difluorobenzophenone.

### SUMMARY OF THE INVENTION

Precise weighing of the monomers and hence controlled setting of the molar monomer ratio make it possible to have influence on the end product. However, it is disadvantageous that this method does not lead to satisfactory reproducibility, since monomers are entrained out of the reaction mixture in an uncontrolled manner with the gas stream (steam and carbon dioxide from the reaction of the auxiliary base with the diol component) and the molar ratio from the precise weighing is thus disturbed. In this way, a polymer with insufficient molar mass is obtained. When attempts are made to take account of this at an earlier stage, in the weighing, the reverse case can occur, specifically that the molar mass becomes so high that the reaction mixture can be discharged and worked up only with difficulty. The polymer thus obtained can therefore be processed only with very great difficulty under some circumstances owing to the high melt viscosity.

Since exact compliance with the product specifications is required on the part of the user, it is an object of the invention to develop a process for preparing polyarylene ether ketones with which the molar mass can be managed and controlled better.

This object is achieved by a process in which the molar mass in the reaction of an aromatic dihalogen compound with a bisphenol in the presence of alkali metal carbonate, alkali metal hydrogencarbonate, alkaline earth metal carbonate and/or alkaline earth metal hydrogencarbonate in a high-boiling solvent to give PAEK is established by, in the course of the polycondensation reaction, bringing the molar mass to the target value by again adding a bisphenol or an organic halogen compound.

### BRIEF DESCRIPTION OF THE DRAWINGS

FIG. 1 shows a schematic of the undisturbed profile of a polycondensation reaction as a sigmoidal curve when the viscosity or the torque is plotted as a function of reaction time.

FIG. 2 is an example of the preparation of PEEK from 4,4′-difluorobenzophenone and hydroquinone.

FIG. 3 shows a schematic of the different reaction profiles in the case of use of either methyl chloride or 4,4′-difluorobenzophenone (BDF).

FIG. 4 shows a schematic of the profile when the feed of methyl chloride into the solution is ended, the degradation of the polymer chains stops and the viscosity remains constant.

### DETAILED DESCRIPTION OF THE INVENTION

The invention provides a process for preparing a polyarylene ether ketone, including adding an aromatic dihalogen compound and a bisphenol to a reactor and conducting a polycondensation reaction in the presence of one or more of an alkali metal carbonate and an alkaline earth metal carbonate in a high-boiling solvent; again adding, during the course of the polycondensation, at least one of a bisphenol and an aromatic dihalogen compound in an amount to achieve a target molar mass of the polyarylene ether ketone.

Examples of suitable aromatic dihalogen compounds are 4,4′-difluorobenzophenone, 4,4′-dichlorobenzophenone, 4,4′-dichlorodiphenyl sulfone, 4,4-difluorodiphenyl sulfone, 1,4-bis(4-fluorobenzoyl)benzene, 1,4-bis(4-chlorobenzoyl)benzene, 4-chloro-4′-fluorobenzophenone and 4,4′-bis(4-fluorobenzoyl)biphenyl. The halogen group is generally activated by a para-carbonyl or -sulfonyl group. In the case of a para-carbonyl group, the halogen is chlorine or preferably fluorine; in the case of a para-sulfonyl group, the halogen may be fluorine or chlorine, although preference is generally given here to chlorine as the halogen owing to sufficient reactivity and low costs. It is also possible to use mixtures of different dihalogen compounds.

Examples of suitable bisphenols are hydroquinone, 4,4′-dihydroxybenzophenone, 4,4′-dihydroxydiphenyl sulfone, 2,2′-bis(4-hydroxyphenyl)propane, 4,4′-dihydroxybiphenyl, bis(4-hydroxyphenyl)ether, bis(4-hydroxyphenyl)thioether, bis(4-hydroxynaphthyl)ether, 1,4-, 1,5- or 2,6-dihydroxynaphthalene, 1,4-bis(4-hydroxybenzoyl)benzene, 4,4′-bis(4-hydroxybenzoyl)biphenyl, 4,4′-bis(4-hydroxybenzoyl)diphenyl ether or 4,4-bis(4-hydroxybenzoyl)diphenyl thioether. It will be appreciated that it is also possible to use mixtures of different bisphenols.

Suitable alkali metal carbonates, alkali metal hydrogencarbonates, alkaline earth metal carbonates and alkaline earth metal hydrogencarbonates derive from lithium, sodium, potassium, rubidium, cesium, magnesium, calcium, strontium or barium. Preferably, a mixture of sodium carbonate and potassium carbonate is used. A small excess of alkali metal carbonate, alkali metal hydrogencarbonate, alkaline earth metal carbonate or alkaline earth metal hydrogencarbonate is typically used, for example an excess of approx. 5% above the stoichiometric amount.

The high-boiling aprotic solvent is preferably a compound of the formula

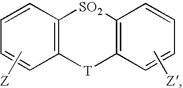

where T is a direct bond, one oxygen atom or two hydrogen atoms; Z and Z′ are each hydrogen or phenyl groups. The high-boiling aprotic solvent is preferably diphenyl sulfone.

The PAEK contains units of the formulae

(—Ar—X—) and (—Ar′—Y—),

where Ar and Ar′ are each a divalent aromatic radical, preferably 1,4-phenylene, 4,4′-biphenylene, and 1,4-, 1,5- or 2,6-naphthylene. X is an electron-withdrawing group, preferably carbonyl or sulfonyl, while Y is another group such as O, S, CH₂, isopropylidene or the like. In this case, at least 50%, preferably at least 70% and more preferably at least 80% of the X groups should be a carbonyl group, while at least 50%, preferably at least 70% and more preferably at least 80% of the Y groups should consist of oxygen.

In the especially preferred embodiment, 100% of the X groups consist of carbonyl groups and 100% of the Y groups of oxygen. In this embodiment, the PAEK may, for example, be a polyether ether ketone (PEEK; formula I), a polyether ketone (PEK; formula II), a polyether ketone ketone (PEKK; formula III) or a polyether ether ketone ketone (PEEKK; formula IV), but other arrangements of the carbonyl and oxygen groups are of course also possible.

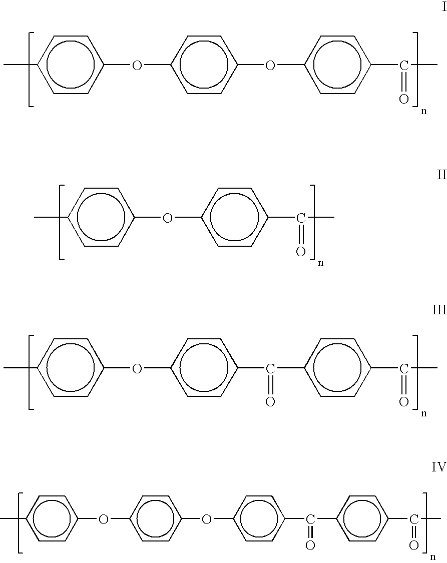

The PAEK is generally partly crystalline, which is manifested, for example, in the DSC analysis by the finding of a crystal melting point Tₘ which in most cases is in the order of magnitude of around 300° C. or higher. However, the teaching of the invention can also be applied to amorphous PAEK. In general, sulfonyl groups, biphenylene groups, naphthylene groups or bulky Y groups, for example an isopropylidene group, reduce the crystallinity.

In the inventive preparation of the PAEK, the molar ratio of bisphenol to dihalogen compound is preferably in the range from 1:1.001 to 1:1.05. This is true especially also in the preparation of PEEK from hydroquinone and 4,4′-difluorobenzophenone. Typically, a concentration of from 25 to 35% by weight of polymer (based on the solvent) is established. It is also preferred that the auxiliary base used is a mixture of sodium carbonate and potassium carbonate in a weight ratio of about 100:5. Owing to the given reactivity of the functional groups and the low solubility of the PAEK at low temperatures, the reaction is typically carried out within the temperature range from approx. 200 to 400° C., preference being given to the range from approx. 250 to 350° C. The reaction end temperature is preferably in the range from 300° C. to 320° C. Since the viscosity of the reaction mixture is a function of the molar mass of the polymer, the reaction progress can be determined by means of the viscosity of the solution, which can be done by known methods. For example, the viscosity can be determined via the torque to be applied by the drive of the stirrer unit.

The bisphenol metered in, generally once the reaction has abated, to achieve the target viscosity may be any bisphenol; examples thereof are the same as specified above for the main reaction. Usually, it is advisable to use the same bisphenol as in the main reaction. “Abatement of the reaction” is understood to mean the time from which the viscosity increases up to the complete end of the reaction only by a maximum of 20%, preferably a maximum of 15%, more preferably a maximum of 10%, in particular a maximum of 5% and most preferably only a maximum of 2.5%.

The organic halogen compound used may be any halogen compound which is capable of reacting with a phenoxide anion with substitution. Suitable halogen compounds are, for example, methyl chloride, methyl bromide, methyl iodide, ethyl chloride, allyl chloride, propargyl chloride, benzyl chloride, additionally the same dihalogen compounds as specified above for the main reaction and corresponding monohalogen compounds, for example 4-fluorobenzophenone or 4-chlorodiphenyl sulfone. In principle, there is additionally a multitude of compounds having the same effect and a good leaving group, for example dimethyl sulfate, methyl tosylate or 4-nitrobenzophenone; their use is equivalent to the use of a halogen compound.

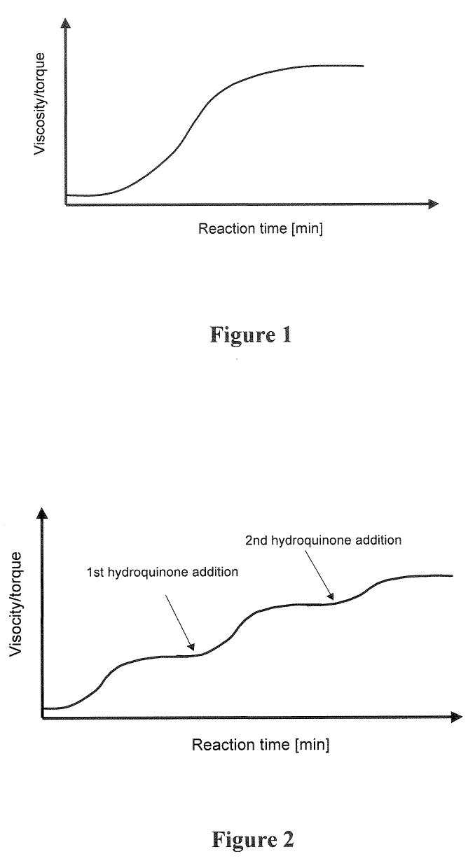

The typical profile of the polycondensation reaction is shown in FIG. 1 and shows a schematic of the undisturbed profile of the reaction as a sigmoidal curve when the viscosity or the torque is plotted as a function of reaction time.

In principle, once the polycondensation reaction has abated, a bisphenol is metered in when, owing to the problems already indicated, such as disruption to the stoichiometry as a result of imprecise weighing with resulting deficiency of bisphenol or loss of bisphenol as a result of the gas stream out of the reactor, the product does not exhibit the desired high viscosity in the reaction mixture. Controlled metered addition of bisphenol from an external vessel into the reaction mixture makes it possible to start the reaction again and allow it to continue to run in a controlled manner. This process step can be repeated several times. This is shown in FIG. 2 by the example of the preparation of PEEK from 4,4′-difluorobenzophenone and hydroquinone.

In exactly the same way, it is possible, when the stoichiometry is so disrupted that the bisphenol is present in excess, once the reaction has abated, to meter an aromatic dihalogen compound of the type as can also be used for the main reaction from an external vessel in a controlled manner into the reaction mixture, in order to start the reaction again and allow it to continue to run in a controlled manner. This process step too can be repeated several times.

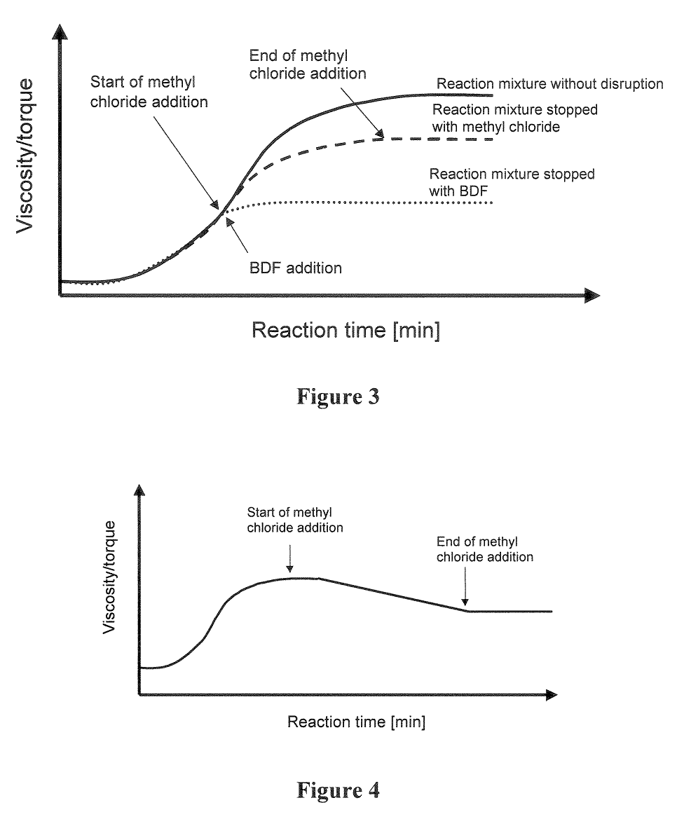

Should, owing to disruption to the stoichiometry as a result of imprecise weighing or loss of the monomers as a result of the gas stream out of the reactor, the reaction profile be such that the product threatens to exceed the desired viscosity, addition of an organic halogen compound, for example methyl chloride or 4,4′-difluorobenzophenone, into the reactor can throttle or immediately stop the reaction. FIG. 3 shows a schematic of the different reaction profiles in the case of use of either methyl chloride or 4,4′-difluorobenzophenone (BDF).

Should, in spite of these countermeasures, the viscosity of the reaction mixture be higher than desired, the possibility exists of lowering the viscosity in a controlled manner by prolonged introduction of an organic monohalogen compound, for example methyl chloride, into the reaction mixture. After an induction phase, the polymer chains are degraded by the methyl chloride, which is manifested in the falling viscosity of the reaction solution. When the feed of methyl chloride into the solution is ended, the degradation of the polymer chains stops and the viscosity remains constant. FIG. 4 shows a schematic of the profile.

The target value of the molar mass of the PAEK corresponds to a solution viscosity in the form of the J value, measured to DIN EN ISO 307 in 97 percent H₂SO₄ (250 mg in 50 ml; 25° C.), of from 80 to 150 ml/g.

Once the reaction has ended, the product is worked up in accordance with procedures known in the art. After the workup, the resulting PAEK is present in particle form. It can be used directly in this form, for example as a coating material, but it can also be granulated and, in this case, if desired, processed to compounds by addition of further substances such as fillers, pigments, stabilizers, other polymers, processing assistants and the like. Such compounds, their preparation and use are known to those skilled in the art.

The invention is illustrated by way of example hereinafter.

### COMPARATIVE EXAMPLE 1

### Without Intervention into the Polycondensation

In a jacketed reactor, 34.6 kg of diphenyl sulfone, 13.1 kg of 4,4′-difluorobenzophenone, 6.6 kg of hydroquinone, 6.6 kg of sodium carbonate and 320 g of potassium carbonate were added successively in solid form at 60° C. The reactor was closed and inertized with nitrogen. Once the jacket temperature had reached 160° C., the stirrer was switched on at 50 rpm. Once the internal temperature had likewise reached 160° C., the reactor was heated slowly to 320° C. The course of the reaction was observed via the torque which was determined from the power consumption by the stirrer motor. The torque rose after approx. 6 hours and, after a further about 2 hours, leveled off at a constant range approx. 55% above the starting level. The product was discharged, cooled, comminuted and worked up in accordance with procedures known in the art, The J value of the product was 134 ml/g.

### EXAMPLE 1

### Intervention into the Polycondensation by Means of Methyl Chloride

In a jacketed reactor, 34.6 kg of diphenyl sulfone, 13.1 kg of 4,4′-difluorobenzophenone, 6.6 kg of hydroquinone, 6.6 kg of sodium carbonate and 320 g of potassium carbonate were added successively in solid form at 60° C. The reactor was closed and inertized with nitrogen. Once the jacket temperature had attained 160° C., the stirrer was switched on at 50 rpm. Once the internal temperature had likewise attained 160° C., the reactor was heated slowly to 320° C. The reaction profile was determined via the torque which was determined from the power consumption by the stirrer motor. The torque rose after approx. 6 hours and signaled the start of the reaction. About 30 minutes later, the torque was approx. 25% above the starting value. Methyl chloride was injected into the tank through a nozzle in the lower part of the reactor in an amount of 20 standard liters/hour. In the course of the introduction, a flattening of the rise in torque was observed. After about 1 hour, the addition of the methyl chloride was stopped and the torque leveled out at a constant range approx. 42% above the starting level. The product was discharged, cooled, comminuted and worked up in accordance with known procedures. The J value of the product was 122 ml/g.

### EXAMPLE 2

### Intervention into the Polycondensation by Means of BDF

The procedure was initially as in Example 1. Once the torque was approx. 25% above the starting value after a total of approx. 6.5 hours, 1000 g of 4,4′-difluorobenzophenone were conveyed into the reactor from a reservoir vessel within a short time through an opening in the lid of the reactor. Approx. 10 minutes after the BDF addition, there was a turning point in the torque and it remained at a constant level for a further 2.5 hours. The level of the torque after BDF addition remained constant at approx. 27% above the starting value. The product was discharged, cooled, comminuted and worked up in accordance with known procedures. The J value of the product was 81 ml/g.

### EXAMPLE 3

### Intervention into the Polycondensation by Means of Methyl Chloride after the end of the Polycondensation

The procedure was initially as in Comparative Example 1. The torque rose after approx. 6.5 hours and leveled out at a constant range approx. 53% above the starting level after a further about 2.5 hours. Once the level had been maintained for a further 30 minutes, methyl chloride was injected into the tank in an amount of 20 standard liters/hour through a nozzle in the lower section of the reactor. After approx. 40 minutes, a slight decline in the torque was measured and continued over a further 4 hours of experiment time. Thereafter, the methyl chloride addition was ended. After a further approx. 30 minutes, there was a turning point in the torque to a constant level approx. 46% above the starting value at the start of the reaction. The product was discharged, cooled, comminuted and worked up in accordance with the known procedures. The J value of the product was 126 ml/g.

### EXAMPLE 4

### Intervention into the Polycondensation by Addition of Portions of Hydroquinone

In a jacketed reactor, 34.6 g of diphenyl sulfone, 13.1 kg of 4,4′-difluorobenzophenone, 6.5 kg of hydroquinone, 6.6 kg of sodium carbonate and 320 g of potassium carbonate were added successively in solid form at 60° C. The reactor was closed and inertized with nitrogen. Once the jacket temperature had reached 160° C., the stirrer was switched on at 50 rpm. Once the internal temperature had likewise reached 160° C., the reactor was heated slowly to 320° C. The course of the reaction was observed via the torque which was determined from the power consumption by the stirrer motor. The torque rose after approx. 5 hours and signaled the start of the reaction. About 5 hours thereafter, the torque was constant approx. 15% above the starting value. In a separate, heatable and stirred vessel, a mixture of 10 parts by weight of diphenyl sulfone and 1 part by weight of hydroquinone was melted at 180° C. 400 ml of this mixture was passed into the reactor through a pipeline. After approx. 10 minutes, an increase in the viscosity was observed via the power consumption by the stirrer motor, which indicated a further reaction of the polymer. After approx. 1 hour, the torque had risen to approx. 25% above the starting value and remained constant. The step was repeated with a further 400 ml of the diphenyl sulfone-hydroquinone mixture and, after 1 hour, the torque had risen to approx. 35% above the starting value and remained constant. Another repetition of this step with 300 ml of the diphenyl sulfone-hydroquinone mixture resulted in another rise in the torque; after 1 hour, a value of approx. 60% above the starting value was achieved; this value remained constant over a further 1.5 hours. Thereafter, the product was discharged, cooled, comminuted and worked up in accordance with known procedures. The J value of product was 138 ml/g.

The present application claims priority to DE 102006022550.3 filed May 15, 2006, the entire contents of which are incorporated herein by reference.

1. A process for preparing a polyarylene ether ketone, comprising
adding an aromatic dihalogen compound and a bisphenol to a reactor and conducting a polycondensation reaction in the presence of one or more of an alkali metal carbonate and an alkaline earth metal carbonate in a high-boiling solvent;
again adding, during the course of the polycondensation, at least one of a bisphenol and an aromatic dihalogen compound in an amount to achieve a target molar mass of the polyarylene ether ketone.

2. The process according to claim 1, wherein if the bisphenol is deficient in the reaction and the polycondensation reaction has abated, the process further comprises starting the reaction again by adding a bisphenol.

3. The process according to claim 1, wherein if the aromatic dihalogen compound is deficient and the polycondensation reaction has abated, the process further comprises starting the reaction again by adding an aromatic dihalogen compound.

4. The process according to claim 1, which further comprises stopping the polycondensation reaction by adding an organic halogen compound.

5. The process according to claim 1, wherein once the polycondensation reaction has abated, the molar mass is lowered by metering an organic monohalogen compound into the reaction.

6. The process according to claim 5, wherein the organic monohalogen compound is methyl chloride.

7. The process according to claim 1, wherein the aromatic dihalogen compound is 4,4′-difluorobenzophenone.

8. The process according to claim 1, wherein the bisphenol is hydroquinone.

9. The process according to claim 8, wherein the aromatic dihalogen compound is 4,4′-difluorobenzophenone.

10. The process according to claim 1, wherein the molar ratio of the bisphenol to the aromatic dihalogen compound is from 1:1.001 to 1:1.105.

11. The process according to claim 10, wherein the bisphenol is hydroquinone.

12. The process according to claim 10, wherein the aromatic dihalogen compound is 4,4′-difluorobenzophenone.

13. The process according to claim 12, wherein the bisphenol is hydroquinone.
